(19) United States
(12) Patent Application Publication
(10) Pub. No.: US 2002/0191932 A1
(43) Pub. Date: Dec. 19, 2002

(54) Adhesion process for polycarbonate-based electro-optic waveguide systems

(76) Inventors: Rebecca Ellen Taylor, San Carlos, CA (US); Susan Patricia Ermer, Redwood City, CA (US); Richard Ronald Barto JR., Cupertino, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/120,194

(22) Filed: Apr. 10, 2002

Related U.S. Application Data
(60) Provisional application No. 60/282,480, filed on Apr. 10, 2001.

(51) Int. Cl. G02B 6/10

(52) U.S. Cl. 385/129; 385/147

(57) ABSTRACT

A process is given to improve adhesion in a polycarbonate-based electro-optic wave guide by treating one surface with oxygen plasma prior to applying a silane.

This application is based on Provisional Application 60/282,480 filed Apr. 10, 2001.

### FIELD OF THE INVENTION

The present invention relates to the adhesion of layers of a wafer. More particularly, the present invention relates to the adhesion between layers in waveguide systems using an acrylate cladding and polycarbonate core.

The present invention relates to polymer modulator fabrication, and more particularly, the invention pertains to methods of producing waveguide systems. Specifically this invention relates to an adhesion process for polymers used in waveguide systems. More specifically, this invention relates to an adhesion process for use with polycarbonate-based electro-optic waveguide systems.

### BACKGROUND OF THE INVENTION

There are several methods used in fabrication of polymers for use in electro-optic devices. Known materials for use in electro-optic devices include both organic and inorganic materials. Semiconductor materials such as gallium arsenide, organic crystalline materials and organic materials prepared by sequential synthesis methods are used as well as electrically poled polymer films containing organic chromophores incorporated either physically to form composites or chemically to form homopolymer materials. See Kirk-Othmer Encyclopedia of Chemical Technology, 4^{th} Edition, Volume 17 (John Wiley & Sons, New York, 1995) pp. 288-302.

When an electric field is applied to electro-optic materials, the highly polarizable electrons in those materials change significantly resulting in an increase in the index of refraction of the materials and a decrease in the speed of light passing through the materials. The change in the index of refraction can be used to impose electric signals onto optical signals to switch optical signals in a network or to control a beam of light.

The most commonly used inorganic material is lithium niobate which possesses an electro-optic coefficient on the of 35 pm/V which results in a typical drive voltage of about 5 volts. Because lithium niobate has a high dielectric constant which results in velocity mismatch of electric and optical waves propagating in the material, a short interaction length and limiting bandwidth results. In one analysis a one centimeter electro-optic modulator constructed from lithium niobate typically has a bandwidth of less the 10 Gigahertz.

In using organic materials systems, one obstacle to overcome is the decay of the poled electro-optic response at the elevated manufacturing and operating temperatures dictated by current electronic technology.

For generally useful devices, higher temperature electro-optic thermal stability is required. In some manufacturing processes, short-term temperature excursions can be high than 300 degrees C. In fabrication, the poling and curing temperatures of an electro-optic polymer for integrated devices may often exceed this limit.

### DESCRIPTION OF THE RELATED ART

Polymers are generally known to peal in adhesion. The are generally recognizes that devices made using similar polymers peel apart during dicing to final dimensions.

### SUMMARY OF THE INVENTION

In a preferred embodiment, an adhesion promotion scheme for waveguide devices is made out of a UV-cured acrylate cladding and a combination of an amorphous polycarbonate and a nonlinear optical chromophore. A preferred amorphous polycarbonate is Aldrich cat. #43,057-9 (APC). A preferred nonlinear optical chromophore is 2-(3-Cyano-4-{2-[5-(2-{4-[ethyl-(2-methoxy-ethyl)-amino]-phenyl}-vinyl)-3,4-dihexyl-thiophen-2-yl]-vinyl}-5,5-dimethyl-5H-furan-2-ylidene)-malononitrile which has the following formula.

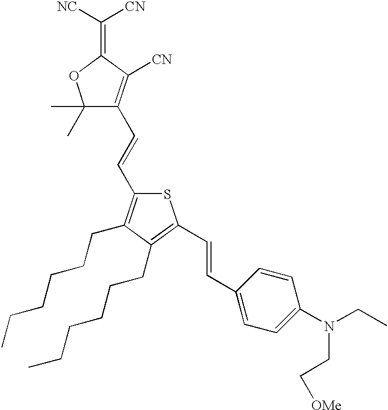

Generally, one applies a silane-based adhesion promoter to the bottom cladding and uses a thin buffer layer based on the polycarbonate material to improve adhesion before applying the core layer. In this circumstance, the adhesion promoter and a buffer layer are combined.

### DESCRIPTION OF THE DRAWINGS

The present invention is described with reference to the accompanying drawings, wherein:

FIG. 1 shows a schematic illustration of an adhesion process of the present invention.

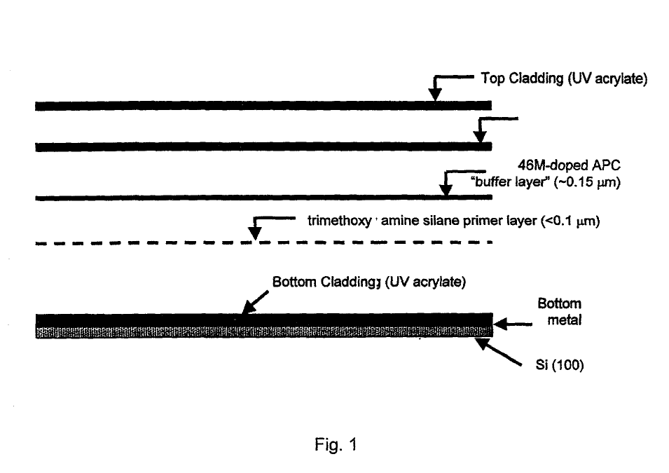

### DETAILED DESCRIPTION OF THE INVENTION

The features of an adhesion process of a preferred embodiment the present invention are presented here. The Bottom Cladding Layer (BCL) is heated to 215° C. following UV cure. A hot plate may be used to heat the BCL. The surface of the BCL is treated with O₂ plasma. Adhesion of the primary layer is performed. Preferably, this is accomplished using a silane. Various trimethoxy and triethoxy silanes but aminoethyl aminopropyl-trimethoxysile is preferred. This can be obtained from Dow Corning as Z6032 (aminoethyl aminopropyl-trimethoxysilane), 5% in methanol. The buffer layer is added. The buffer layer preferably is approximately 0.1-0.2 μm thick amphorus polycarbonate (APC), and preferably contains 15 weight percent chromophore dye, with respect to APC (range of dye concentration 0-25%). The core layer is applied. The core layer preferably contains 25% chromoophore dye in APC (range 20-50%). The core layer is preferably heat treated at 200° C.

Wafers made according to this process no longer fall apart. Additionally, the absolute value and variability of optical loss are both improved.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments.

What is claimed is:

1. A method of improving adhesion in a polycarbonate-based electro-optic wave guide comprising treating one surface with oxygen plasma prior to applying a silane.
